(19) United States
(12) Patent Application Publication
(10) Pub. No.: US 2019/0066127 A1
(43) Pub. Date: Feb. 28, 2019

(54) SYSTEMS AND METHODS FOR COMPARING MEDIA

(71) Applicant: Slicethepie Limited, Reading (GB)

(72) Inventors: Tabitha Trahan, Plainfield, CT (US); David Anthony Courtier-Dutton, Hampshire (GB); Grace Margaret Hammond, Reading (GB)

(21) Appl. No.: 16/117,228

(22) Filed: Aug. 30, 2018

Related U.S. Application Data
(60) Provisional application No. 62/552,487, filed on Aug. 31, 2017.

(51) Int. Cl. G06Q 30/02

(52) U.S. Cl. CPC G06Q 30/0201; G06Q 30/0282; G06Q 30/0203

(57) ABSTRACT

A representative method for comparing media includes: providing a user interface configured to provide media to a reviewer and receive a reviewer input associated with the media, the reviewer input corresponding to a set of attributes exhibited by the media; and providing a processor, having processor circuitry, configured to: receive information corresponding to a desired set of attributes; receive information corresponding to the reviewer input; automatically compare the information received from the reviewer to the desired set of attributes; and automatically generate a report based, at least in part, on the information received from the reviewer and the desired set of attributes.

### CROSS REFERENCE TO RELATED APPLICATION

This utility application claims the benefit of and priority to U.S. Provisional Application 62/552,487, filed on 31 Aug. 2017, which is incorporated by reference herein in its entirety.

### BACKGROUND

### Technical Field

The disclosure generally relates to systems and methods involved with comparing perceptions of various media.

### SUMMARY

Systems and methods for comparing media are provided. An example embodiment, among various others, is a method that comprises: providing a user interface configured to provide media to a reviewer and receive a reviewer input associated with the media, the reviewer input corresponding to a set of attributes exhibited by the media; and providing a processor, having processor circuitry, configured to: receive information corresponding to a desired set of attributes; receive information corresponding to the reviewer input; automatically compare the information received from the reviewer to the desired set of attributes; and automatically generate a report based, at least in part, on the information received from the reviewer and the desired set of attributes.

Another example embodiment is a system for comparing media. The system comprises: a user interface configured to provide media to a reviewer and receive a reviewer input associated with the media, the reviewer input corresponding to a set of attributes exhibited by the media; and a processor, having processor circuitry, configured to: receive information corresponding to a desired set of media attributes; receive information corresponding to the reviewer input; automatically compare the information received from the reviewer to the desired set of attributes; and automatically generate a report based, at least in part, on the information received from the reviewer and the desired set of attributes.

Another example embodiment is a non-transitory computer-readable medium having stored thereon computer-executable instructions for performing collection and automatic analysis of opinions of media. The computer-executable instructions are configured to: provide media to a reviewer; receive a reviewer input associated with the media, the reviewer input corresponding to a set of attributes exhibited by the media; receive information corresponding to a desired set of attributes; receive information corresponding to the reviewer input; automatically compare the information received from the reviewer to the desired set of attributes; and automatically generate a report based, at least in part, on the information received from the reviewer and the desired set of attributes.

Other systems, methods, features, and advantages of the present disclosure will be or may become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of a representative networked environment in which an example embodiment of a system for comparing media is implemented.

FIG. 2 is a flowchart depicting an example embodiment of a method for comparing media.

FIG. 3 is a schematic diagram of an example embodiment of a system for comparing media.

FIG. 4A-4D are schematic diagrams depicting a representative graphical user interface that may be used to implement functionality of an example embodiment.

FIG. 5 is a radar graph depicting that may be used in an example embodiment.

FIG. 6 is a schematic diagram depicting a representative graphical user interface that may be used to implement functionality of an example embodiment.

FIG. 7 is a flowchart depicting functionality of another example embodiment.

FIGS. 8A and 8B are tables depicting representative functionality of an example embodiment.

FIG. 9 is a flowchart depicting functionality of another example embodiment.

FIG. 10A is a schematic diagram depicting functionality of another example embodiment.

FIG. 10B is a representative radar graph that may result from the process of FIG. 10A.

FIGS. 11, 12A, 12B, 13-15, 16A, 16B, 17A, and 17B are schematic diagrams depicting portions of example embodiments of reports.

### DETAILED DESCRIPTION

As will be described in detail, the present disclosure involves comparing media of various types. In particular, the systems and methods involve comparisons of consumer and owner perceptions of media (e.g., audio, video, still images, brands) in order to facilitate strategic decision-making such as those regarding branding and collaborations, for example. In some embodiments, the emotional evocations of multiple consumers with respect to media are compared to owner-desired perceptions. Differences discovered during the comparison may be used to inform owner decision-making in order to reinforce or alter consumer perceptions. By way of example, in some embodiments, a brand may be evaluated based upon various criteria to determine a baseline consumer perception. Thereafter, if the owner of the brand desires to steer media content to better match the baseline consumer perception towards a particular attribute (e.g., sexy, trusted, etc.), media exhibiting the desired attribute may be used in association with the brand for better matching consumer perception. It should be noted that the media selected for altering consumer perception may have been previously evaluated, with associated attributes stored in a searchable database. Thus, in some embodiments, a system output may be one or more media selections configured with appropriate attributes for achieving the desired result.

In some embodiments, consumers (users) providing information related to emotional evocation provide such information as a system input, which may be accomplished by entering a web portal using personal login and password information. An example of a system that may be used for receiving such inputs is described in U.S. Pat. No. 9,336,212, issued on May 10, 2016 and entitled Systems and Methods for Collection and Automatic Analysis of Opinions on Various Types of Media, which is incorporated by reference herein in its entirety. Once granted access, users may be presented with a number of review category options: video media, music, fashion, branding, etc. The nature of questions included in the review process is related to the review category selection. In some embodiments, a textbox for a free text item review and a rating (e.g., a slider measuring “how much do you like this item”) may be included. The text and rating may be used to up-weight and down-weight user scores. Once a review has been accepted, the user may be directed back to the selection screen.

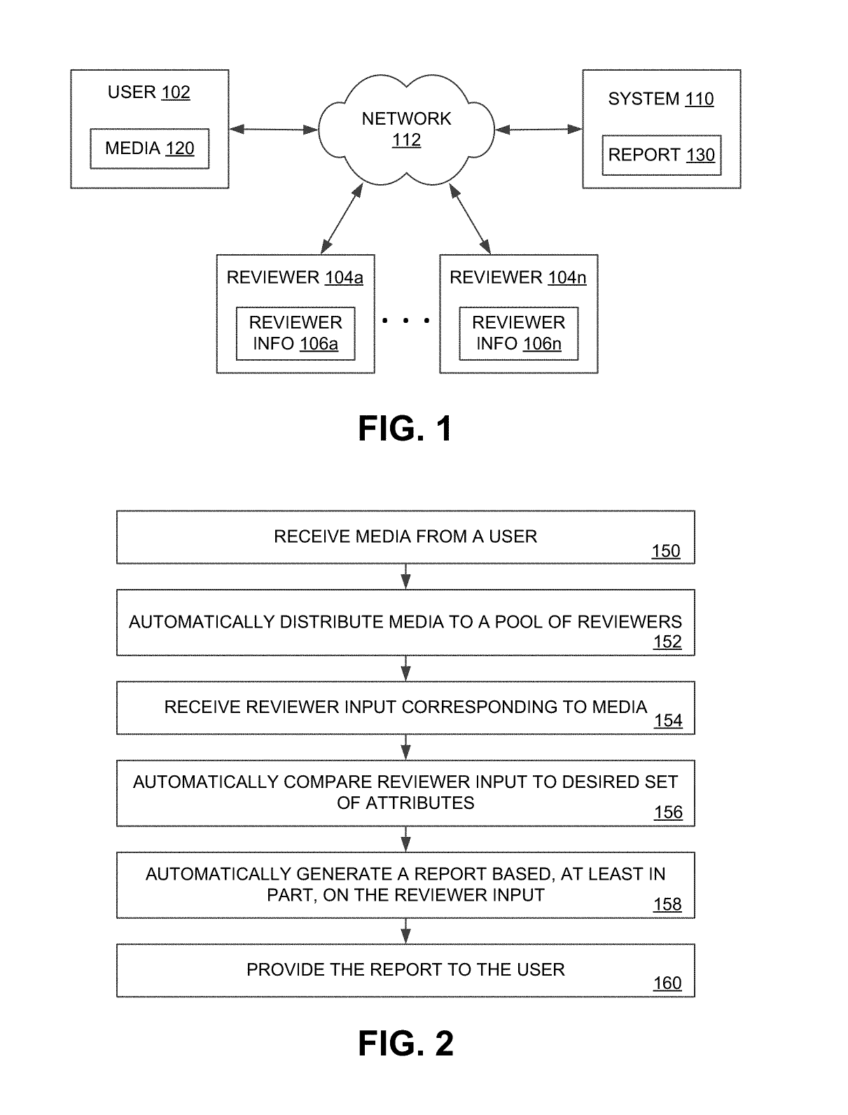

In this regard, FIG. 1 is a schematic diagram of an example embodiment of a system for comparing media implemented in a networked environment. As shown in FIG. 1, a user 102 and multiple reviewers (e.g., reviewers 104a-104n) communicate with system 110 via a communications network 112. The communications network may comprise one or more of wired or wireless networks and may be implemented in one or more of various communications protocols for communicating information.

In the embodiment of FIG. 1, system 110 receives media content (e.g., media 114) that is provided by user 102 for review. By way of example, a user may upload media to a server of the system via the Internet. The system 110 also manages interactions with reviewers. In some embodiments, this may involve registering reviewers with the system, sorting reviewers into pools, and managing reviewer accounts. Additionally, system 110 validates and grades information provided by the reviewers (e.g., information corresponding to perceptions associated with one or more attributes) and generates reports that are provided to the users.

User 102 and the reviewers 104 may interact with network 112 and system 110 via various devices/systems. By way of example, a computer workstation or portable electronic device (e.g., a mobile phone) may be used.

In operation, system 110 receives information from user 102 that is used to establish the parameters of the interaction. By way of example, the user may provide information that uniquely identifies the user and which indicates the extent of review that is being requested. The user is also enabled to provide the media for review to system 110, such as by uploading the media (e.g., media 120) to the system via network 112. Notably, media 120 may be provided in one or more files of various formats.

Responsive to the receipt of the media 120 and the request of the user 102 for a review, the system designates one or more pools of reviewers to provide information about the media. In this example, the pool including reviewers 104a and 104n are designated. These reviewers provide information 106a and 106n, respectively, to the system 110. Notably, various manners of providing information may be used, such as scaled responses to various attributes and free-form text-based review, and combinations thereof, among possible others as may be prompted by the system. The system 110, in turn, correlates the information with other information (e.g., information corresponding to reviewer effectiveness) and generates a report 130 that is provided to the user.

FIG. 2 is a flowchart depicting an example embodiment of a method for comparing media. As shown in FIG. 2, the method (e.g., functionality provided by system 110) may be construed as beginning at block 150, in which media is received from a user for review. In some embodiments, the media is automatically distributed to a pool of reviewers (such as depicted in block 152) based on reviewer profiles. Notably, a user interface (e.g., a user interface associated with a website) may be used to provide the media to a reviewer and receive reviewer input associated with the media.

In block 154, reviewer input corresponding to the media is received from the reviewers. In some embodiments, reviewer input is validated (such as by determining whether the information appears to be thorough) and graded (such as by determining how well the reviewer input ranks among the reviewer input provided by other reviewers).

In block 156, reviewer input is automatically compared to a desired set of attributes. Thereafter, a report based at least in part on the reviewer input is automatically generated (block 158). In some embodiments, generating the report includes automatically searching a database of reviewed media and selecting one of the reviewed media exhibiting at least one attribute identified as lacking between the reviewer input and the desired set of attributes. Notably, identifying one of the reviewed media as exhibiting an attribute lacking in the user's media may enable changes to be made for steering perceptions of the media (e.g., media associated with a particular brand). In block 160, the report is provided to the user, such as via a communications network.

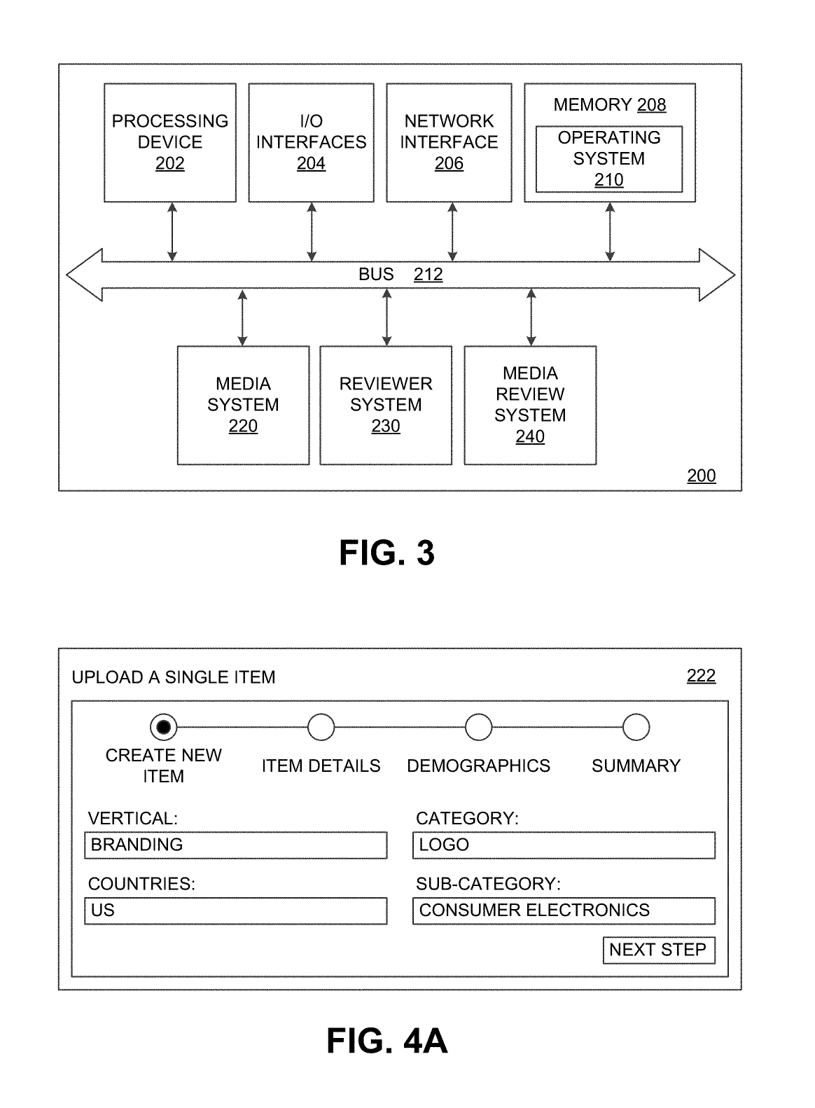

It should be noted that various functionality described above may be implemented in hardware, software and/or combinations thereof. For instance, one or more computers (configured as servers, for example) may be provided to perform at least some of the functionality described above. FIG. 3 is a schematic diagram of an example embodiment of such a system.

As shown in FIG. 3, system 200 incorporates a processing device (processor) 202, input/output interfaces 204, a network/connectivity interface 206, a memory 208, and an operating system 210, with each communicating across a local data bus 212. Additionally, system 200 includes a media system 220, a reviewer system 230 and a media review system 240, each of which may be stored in memory.

The processing device 202 may include a custom made or commercially available processor, a central processing unit (CPU) or an auxiliary processor among several processors, a semiconductor-based microprocessor (in the form of a microchip), one or more application specific integrated circuits (ASICs), a plurality of suitably configured digital logic gates, and other electrical configurations comprising discrete elements both individually and in various combinations to coordinate the overall operation of the system.

The memory 208 may include any one or a combination of volatile memory elements (e.g., random-access memory (RAM, such as DRAM, and SRAM, etc.)) and nonvolatile memory elements. The memory typically comprises native operating system, one or more native applications, emulation systems, or emulated applications for any of a variety of operating systems and/or emulated hardware platforms, emulated operating systems, etc. For example, the applications may include application specific software. In accordance with such embodiments, the components are stored in memory and executed by the processing device.

One of ordinary skill in the art will appreciate that the memory may, and typically will, comprise other components which have been omitted for purposes of brevity. Note that in the context of this disclosure, a non-transitory computer-readable medium stores one or more programs for use by or in connection with an instruction execution system, apparatus, or device.

Network/connectivity interface 206 comprises various components used to transmit and/or receive data over a networked environment. When such components are embodied as an application, the one or more components may be stored on a non-transitory computer-readable medium and executed by the processing device.

Generally, media system 220 receives media content that is provided by a user for review via the network/connectivity interface. Reviewer system 230, which manages interactions with reviewers, assigns a pool of reviewers to provide reviewer inputs about the media. In particular, reviewer system 230 receives information corresponding to demographics of interest to the user and, based on this information, assigns an appropriate pool of reviewers. Notably, the assigned pool of reviewers may be selected based on one or more of various criteria, such as whether the reviewer is currently logged into the system and available for providing a review. Media review system 240 then validates and grades the reviewer inputs and generates a report that is provided to the user.

In an example embodiment of a system (such as system 200 of FIG. 3), a user establishes an account, uploads media (audio, video, still images, etc.), and orders market research based on the media. In some embodiments, the user is able to select the type of research they desire and, on payment of a fee, for example, the system may designate the media for review by reviewers. In response to determining that the user is seeking to steer the baseline consumer perception associated with the media towards a particular attribute, the system may prompt the user for a set of attributes. By way of example, the attributes may correspond to current (e.g., owner) perceptions of the media. In some embodiments, the attributes may additionally or alternatively correspond to desired future (e.g., consumer) perceptions of the media.

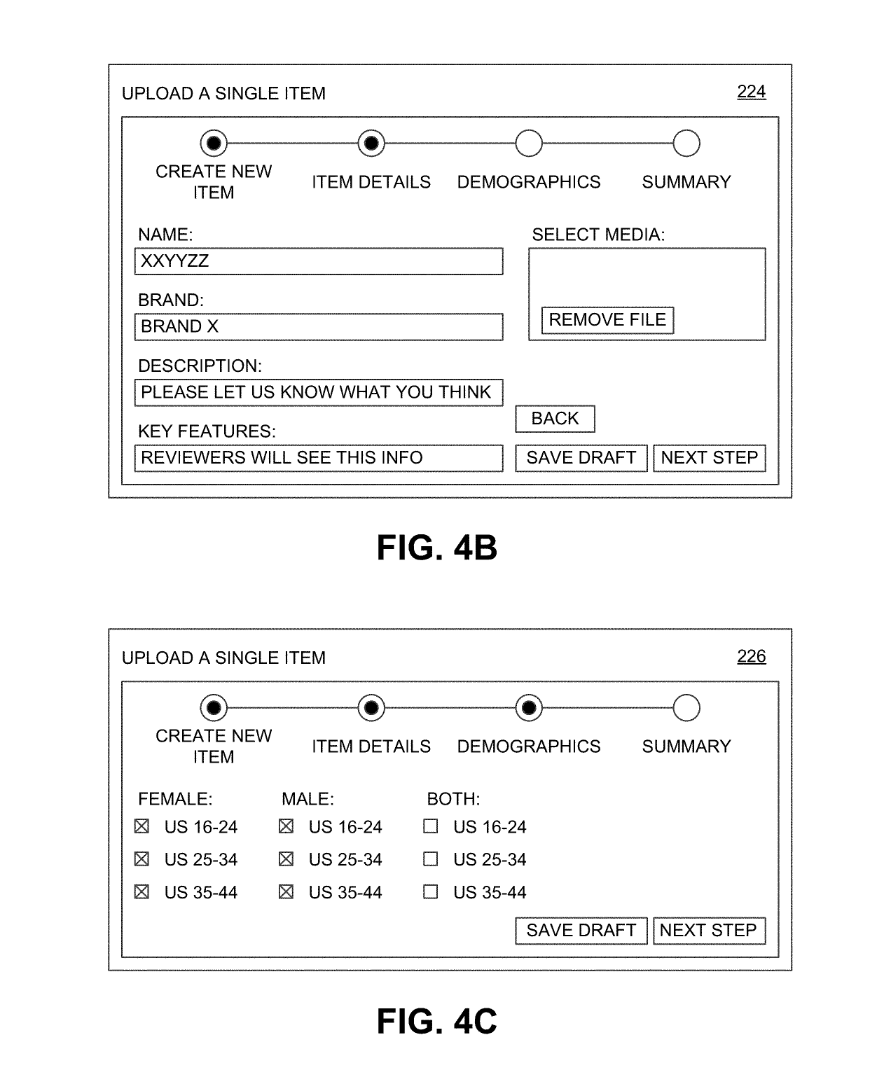

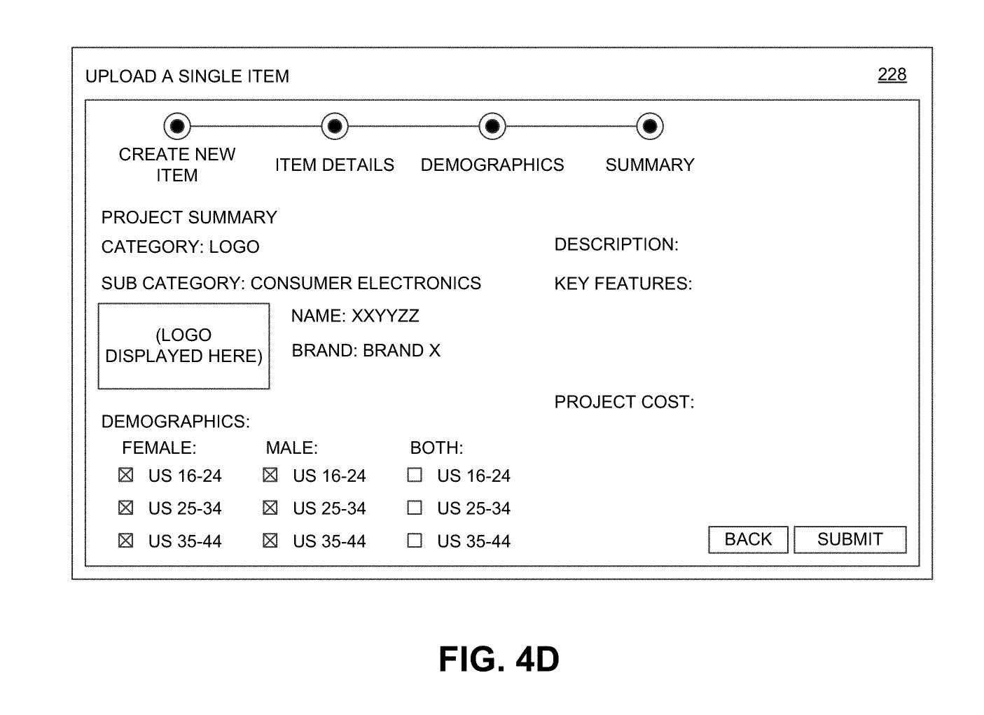

An example of a user interface that may be used to facilitate upload of media for review is depicted in FIGS. 4A-4D. As shown in FIG. 4A, graphical user interface (GUI) 222 facilitates a web-based user interaction that involves the process steps of creating a new item (e.g., uploading media content for review), providing details associated with the media content, identifying demographics of interest, and summarizing the submission. In some embodiments, progress through the process may be displayed to the user via a progress bar (e.g., the progress indicator displayed at the top of FIG. 4A).

For the step of creating a new item, GUI 222 enables the user (e.g., the person submitting the media content) to associate various descriptors with the media content via various fields, text boxes, radio buttons, and/or associated drop-down menus, for example. For instance, the user may select a “Vertical” descriptor, which indicates a vertical category for the media content (e.g., branding, commercials, music, fashion, etc.). The user may also select: a “Country” descriptor, which indicates a country for testing the media content; a “Category” descriptor, which indicates the category for the media content (e.g., logo); and, a “Sub-category” descriptor, which indicates a subcategory that best identifies the service and/or product associated with the media content (e.g., consumer electronics).

For the step of providing details associated with the media content, GUI 224 (FIG. 4B) enables the user to enter a “Name” of media content and a “Brand” of the media content. GUI 222 may also facilitate entry of a “Description” that enables the user to provide information regarding brand perception, for example. “Key features” may also be entered, which may be viewable by the pool of reviewers assigned to review the media content. Provisions also are provided for uploading the media content, such as by browsing to and attaching one or more files.

For the step of identifying demographics of interest, GUI 226 (FIG. 4C) enables the user to select from among various demographic groups (e.g., preselected demographic groups). By way of example, the user may be enabled to select among: females in age groupings of 16-24, 25-34, and 35-44; males in age groupings of 16-24, 25-34, and 35-44; or both females and males in age groupings of 16-24, 25-34, and 35-44. Notably, various other grouping may be provided for selection.

For the step of summarizing the submission, GUI 228 (FIG. 4D) enables the user to review the entries made on the previous screens prior to formally submitting the information for review. In this embodiment, actuation of the “Submit” button completes the submission of the media content for review and initiates the process of distributing the media content to a pool of reviewers.

It has been estimated that ninety percent of all purchasing decisions are made subconsciously and are almost entirely driven by emotion rather than logic. As with human relationships, the strength of a consumer's emotional relationship with a brand is based on the resonance with, and respect for, the emotional brand values. To build and retain brand equity brands must ensure that every campaign, commercial, soundtrack, voiceover and digital asset underpins and reinforces those emotional brand values.

Based on this understanding, embodiments may be used to enable the quantitative benchmarking of core emotional brand values against the actual consumer perception of brand values at any moment in time. In some embodiments, accurate measurements of the emotional brand values associated with any piece of media (e.g., a song, a video, a marketing message or imagery) may be obtained and then correlated to demonstrate precisely how close a match that media is to a target brand.

In some embodiments, a user or agency of a brand ‘defines’ the emotional brand values/positioning via an online tool, which provides a graphical user interface for facilitating user interaction and receiving associated information. Next, many individuals (e.g., several hundred individuals) or ‘reviewers’ do the same, either on the brand or on a piece of media content the owners of the brand are considering using. The resultant outputs are passed through a number of algorithms and the output reveals the closeness of match. This may permit identification of where and why there is misalignment, either generally or by any desired demographic. In some embodiments, the whole process takes under 24 hours and is fully automated.

Embodiments of the process are underpinned by rigorous academic methodologies (Asmus 1989/Aaker 1997/Müllensiefen 2014), re-engineered via machine learning technologies and powered by a strong consumer community. Starting with over one hundred carefully selected adjectives, calibration was achieved by testing hundreds of brands and media with hundreds of thousands of consumers, and then using principal component analysis (PCA) and variable reduction techniques to statistically identify twelve adjectives that captured over 95% of the emotional variance of any brand. These adjectives include funky, gentle, happy, honest, innovative, peaceful, personal, pioneering, playful, pleasant, positive, and sexy. The process also calculated the appropriate weighting for each word and the complex matrix interrelationships between them.

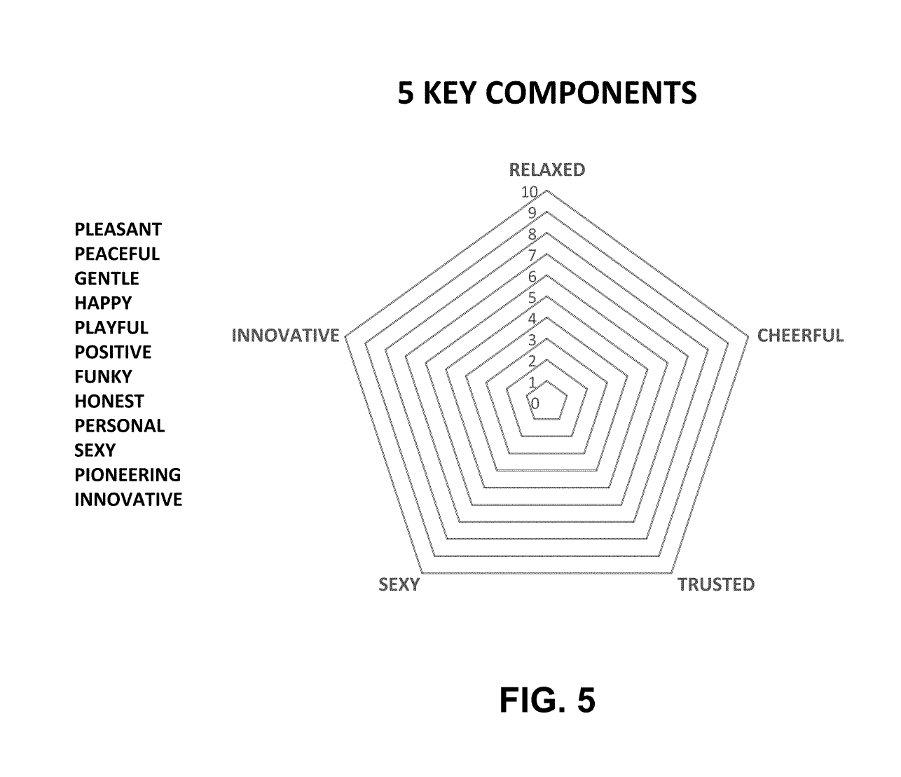

The selected adjectives were then statistically grouped (using PCA) into five distinct components, which include relaxed, innovative, cheerful, trusted, and sexy. In particular, the following groupings of adjectives within their respective components are: component ‘relaxed’ includes the adjectives pleasant, peaceful, and gentle; component ‘innovative’ includes the adjectives pioneering and innovative; component ‘cheerful’ includes the adjectives happy, playful, positive, and honest; component ‘trusted’ includes the adjectives honest and personal; and component ‘sexy’ includes the adjective sexy. A representative radar graph is shown in FIG. 5 that may be used to plot the value of each component for measuring a brand match. Note that the scale on the graph corresponds to reviewer scoring that will be described in greater detail later.

As mentioned before, in determining applicable components and weightings for steering a brand, information corresponding to consumer perceptions and owner schema are collected. This may be facilitated by collecting the information for comparison using an embodiment of the system, such as by collecting information from two separate groups (i.e., owners and reviewers) regarding a media/brand or collecting information about two media/brand items.

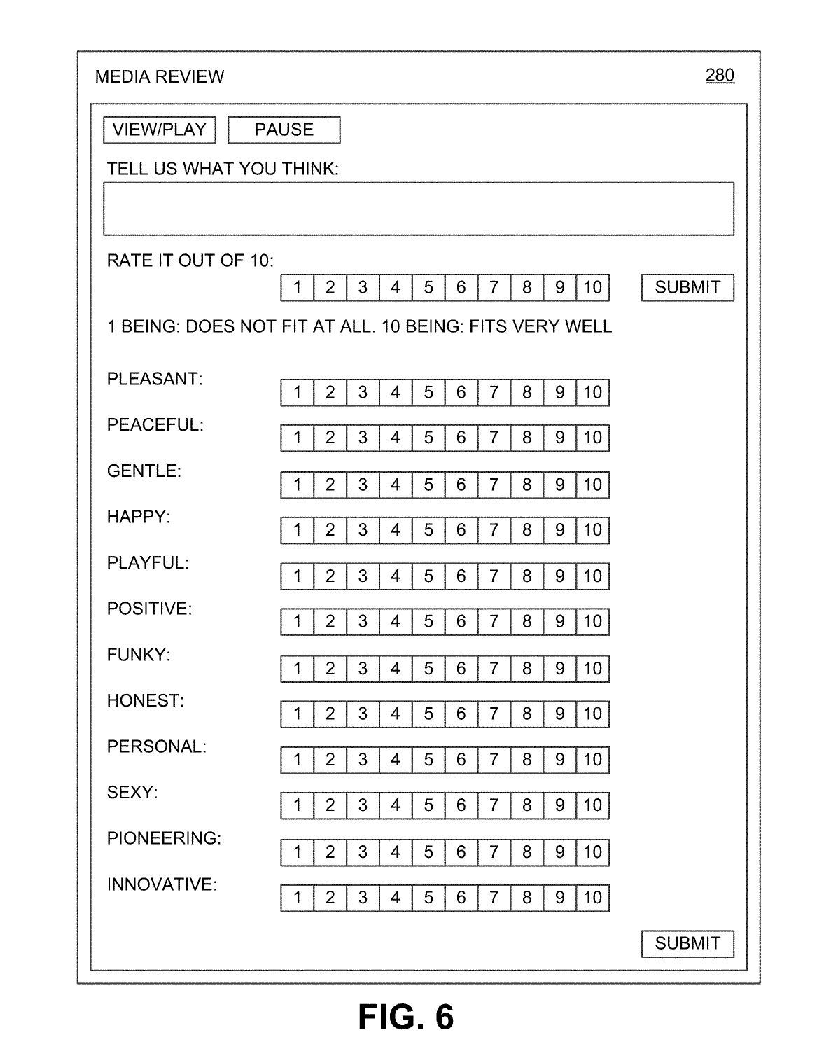

FIG. 6 depicts an example embodiment of a GUI 280 (e.g., a GUI associated with reviewer system 230 of FIG. 2) that may be used for receiving reviewer inputs corresponding to a brand that is to be steered. As shown in FIG. 6, GUI 280 enables a reviewer to provide information corresponding to the media content submitted for review. In particular, a reviewer may: provide a freeform description (such as via a text box); rate the media content by scoring the media content on a designated scale; and, select a score for each of the selected adjectives. This information is then complied with information provided by other reviewers of the pool to create a report that is provided to the user (e.g., the provider of the media content).

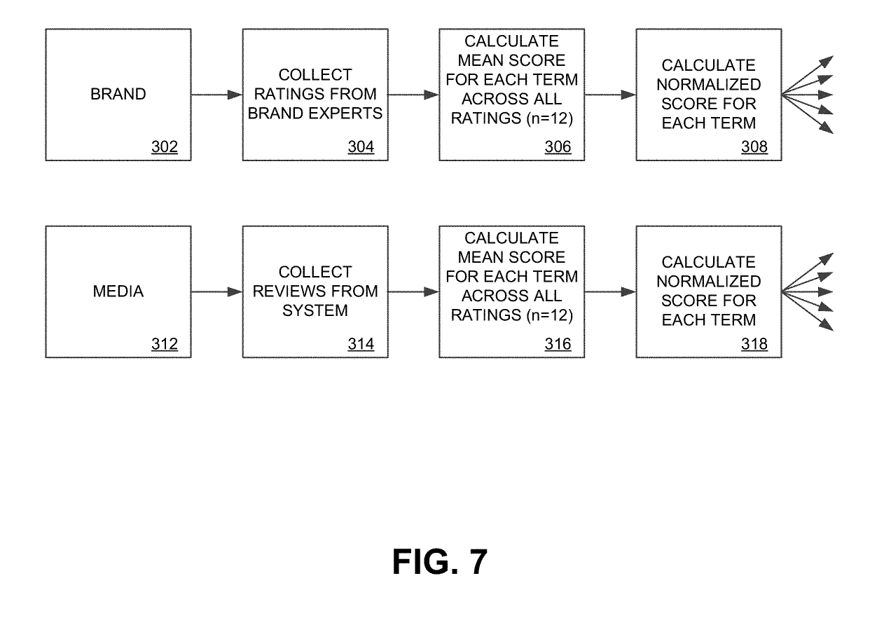

In FIG. 7 (and with continuing reference to system 200 of FIG. 2), an example embodiment in which two media/brand items are compared is depicted. As shown in FIG. 7, information (e.g., a logo, media associated with an ad campaign, etc.) corresponding to a brand that is to be steered is uploaded to media system 220 via an associated interface/website (block 302). Reviewer inputs are then collected, in this case, from brand experts (block 304). By way of example, each adjective is rated on a 0-10 Likert scale for its fit to the brand. In block 306, the mean is calculated for each adjective, with the average score being normalized to the scale of the original data using the mean and standard deviation (block 308). These twelve normalized (or ‘z-score’) scores are then used for component score calculation as will be described in greater detail later.

Similarly, information corresponding to a media item that is being considered for use with the brand is uploaded to media system 220 via an associated interface/website (block 312). Reviewer inputs from a pool of reviewers are then collected using reviewer system 230 (block 314). Once again, each adjective is rated on a 0-10 Likert scale, but this time for its fit to the media. In block 316, the mean is calculated for each adjective, with the average score being normalized to the scale of the original data using the mean and standard deviation (block 318). These twelve normalized (or ‘z-score’) scores are then used for component score calculation.

With respect to the use of reviewers, in some embodiments, a media item is rated by two hundred unique users, although the number of reviewers may vary, such as based on client requests. However, the use of one hundred or more reviewers is preferred.

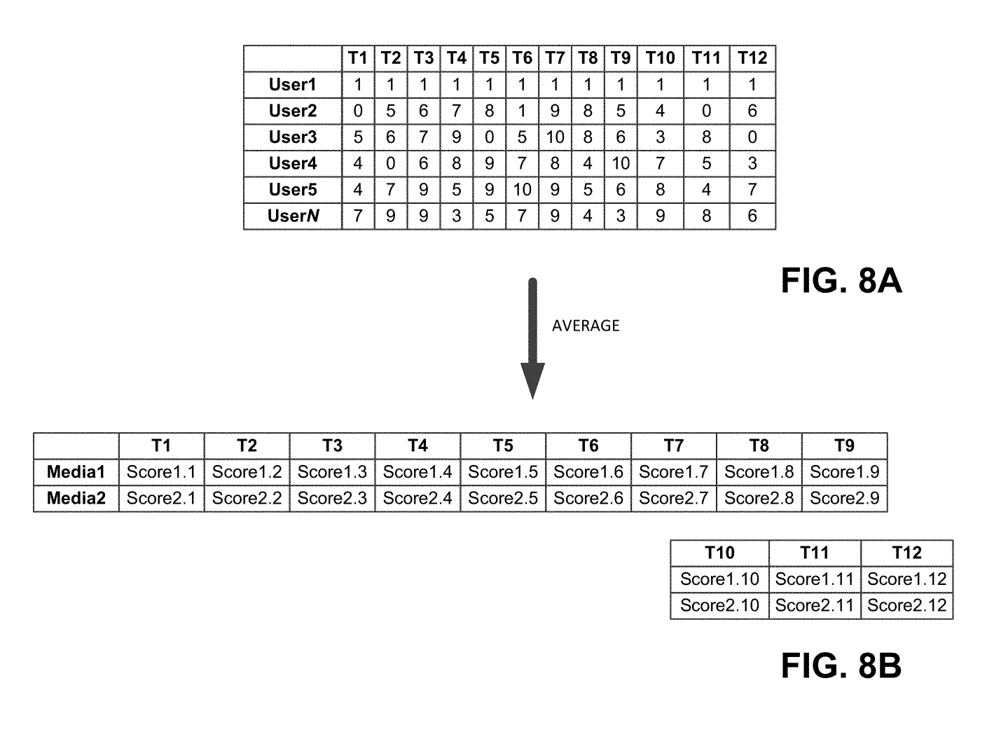

Representative reviewer inputs are depicted in FIG. 8A, in which ratings between 0-10 are used (0=no fit, 10=complete fit) for each term (i.e., adjective). As shown in FIG. 8B, the reviewer inputs are averaged resulting in a single score for each term. Once the final term scores are computed for each media item, the scores are normalized in accordance with the current population mean (M) and standard deviation (SD). By way of example, the equation, z−score(n)=(Term n−m)/sd, may be used; where n=1-12, m is the mean of Term n for all media items tested, and sd is the standard deviation of Term n for all media items tested.

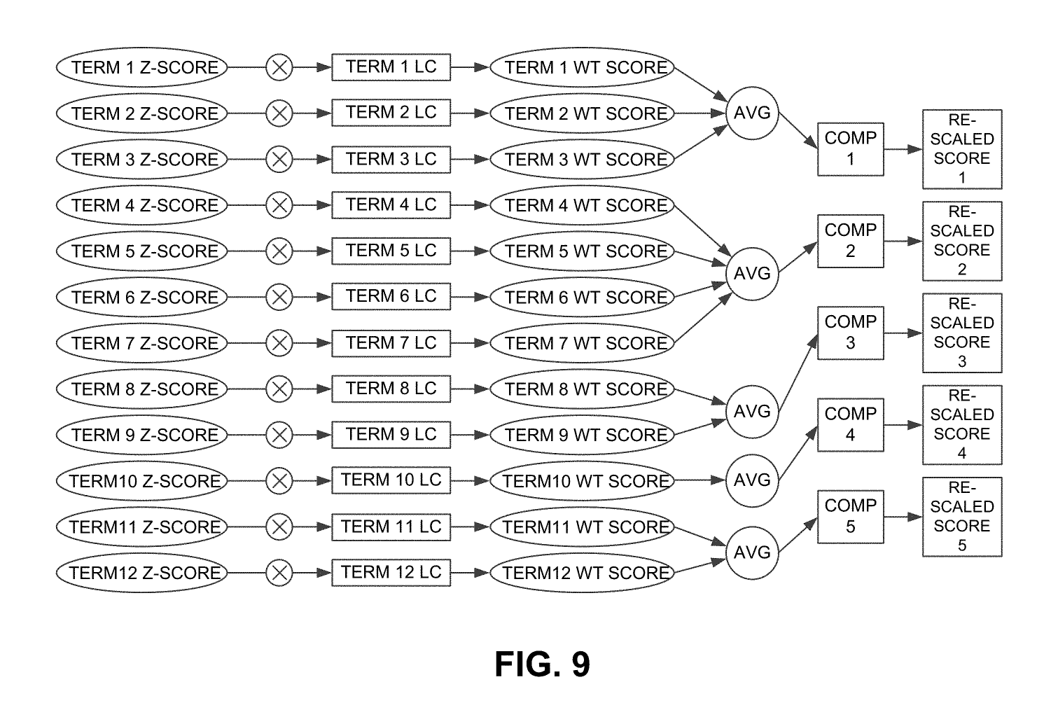

These scores are weighted by their term's individual mathematical coefficient as shown in FIG. 9. By way of example, the equation, Weighted Average n=z−score*C, may be used; where n=1-12, z-score is the normalized term score based on the global term m and sd, and C is the constant specific (loading coefficient, “LC” in FIG. 9) to term n. Such normalization requires explicit knowledge of the mean and standard deviation for each term with respect to the system population. As these numbers (m and sd) may be updated to reflect current trends within the system population so may the respective constants for each term (C(n)). However, the terms that contribute to a specific component do not change. The product of the average term score and the constant is a weighted average (“WT Score” in FIG. 9) that is specific to each media item and to each term. These terms are strategically combined to render the underlying emotional components (i.e., the five components) that are used for comparison and future decision-making processes. For instance, the scores are rescaled and the scores are reported. Various scores may be used for scoring and/or rescaling, such as 1-10 or 1-100, for example.

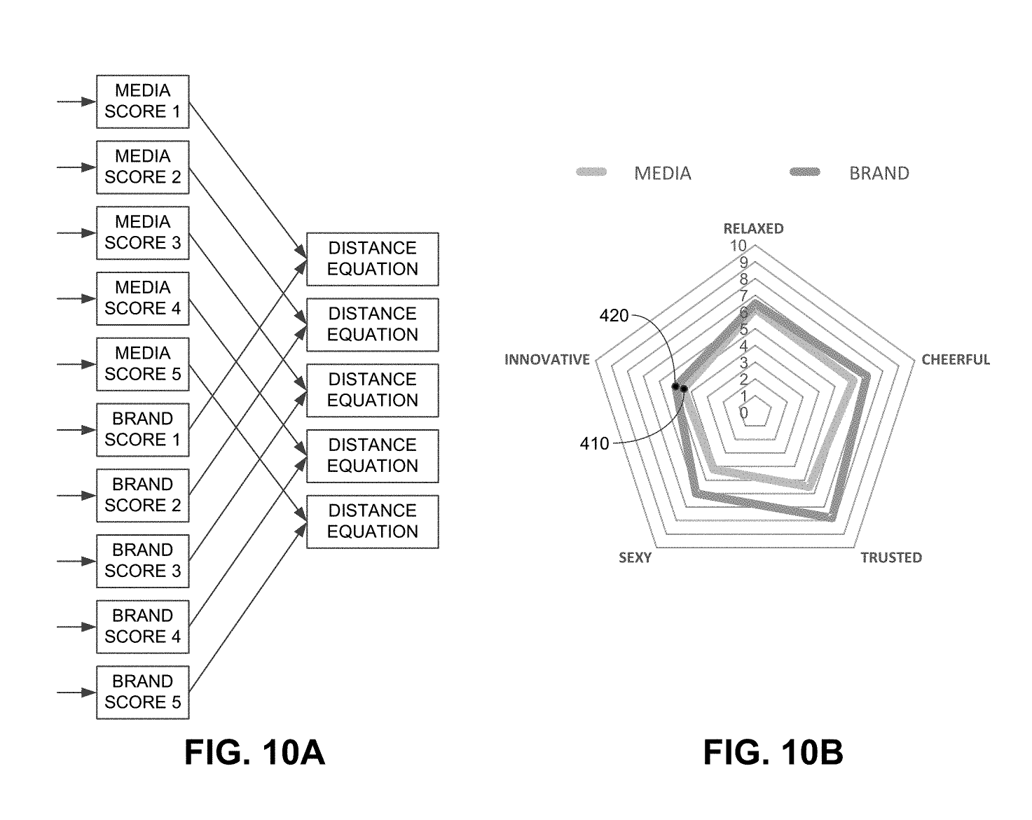

Once all component scores are calculated and rescaled for both the media/brand consumer perception and the media/brand owner schema, the results may be plotted, such as on a radar graph. An example embodiment of such a graph is depicted in FIG. 10B, wherein each of the polynomials represents a corresponding one of the data sets. Example data points depicted include data point 410, which corresponds to Media Score 5 (associated with the “Innovative” component), and data point 420, which corresponds to Brand Score 5.

Differences (i.e., the distance) between the consumer and owner perceptions are calculated (such as depicted in FIG. 10A using a distance equation) and reported. Thus, the relative distance between each component and then an overall measure of distance between the two groups is presented.

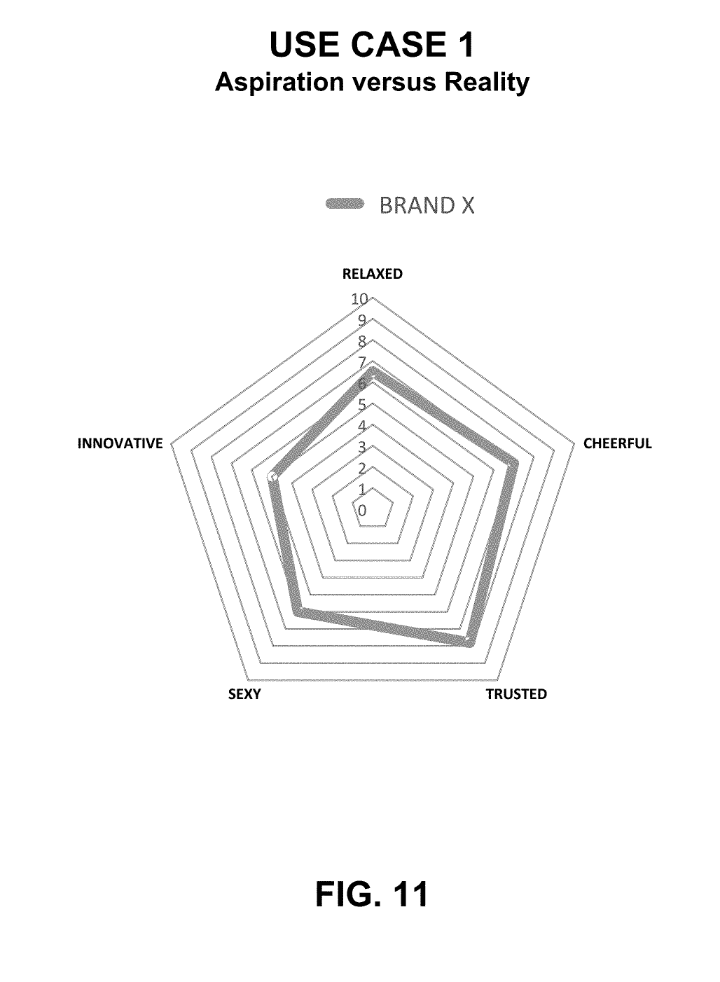

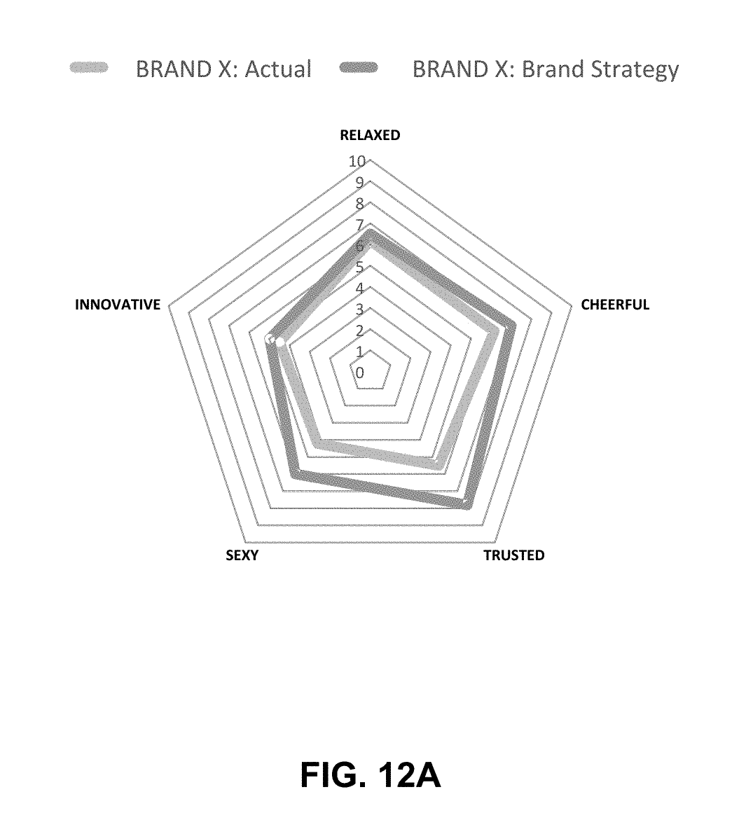

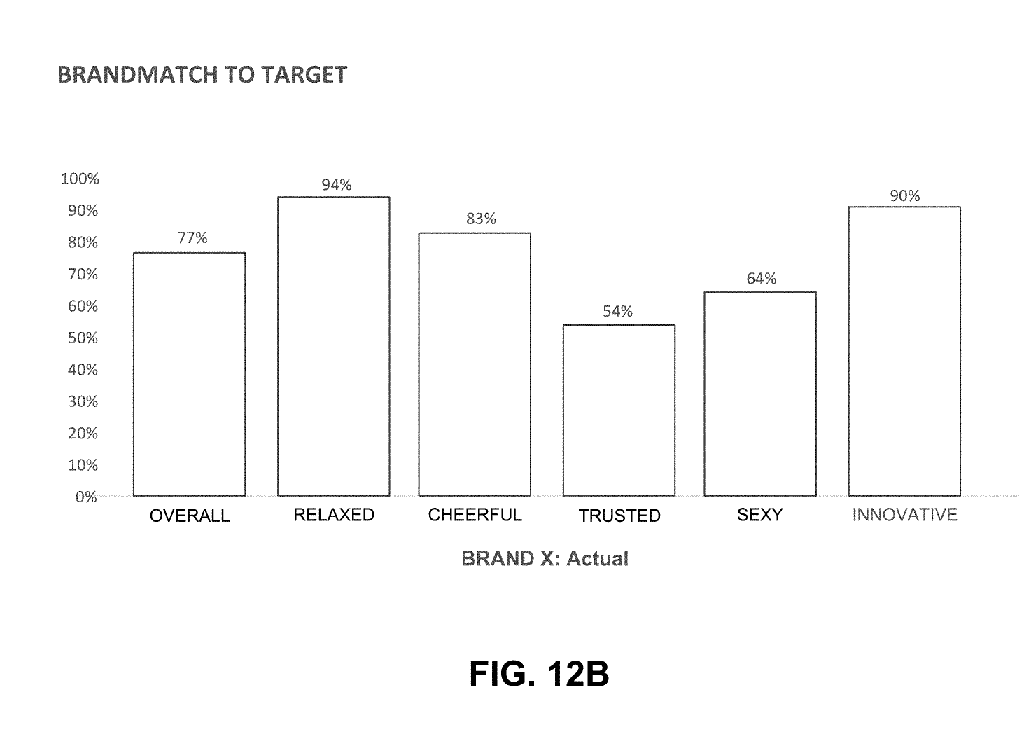

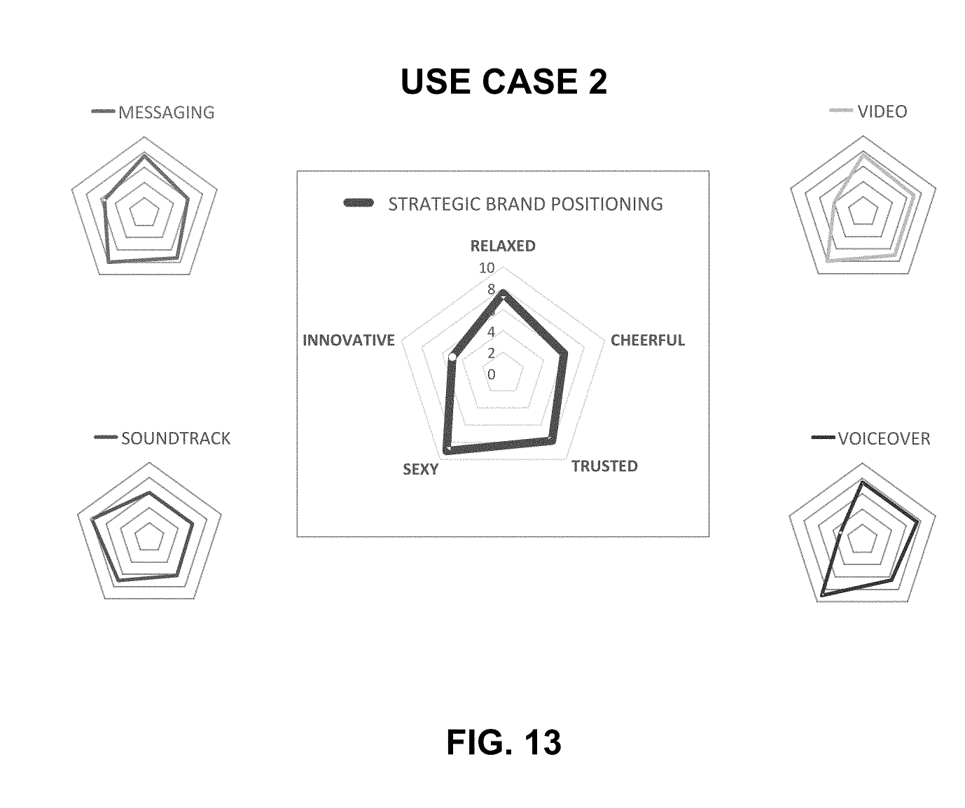

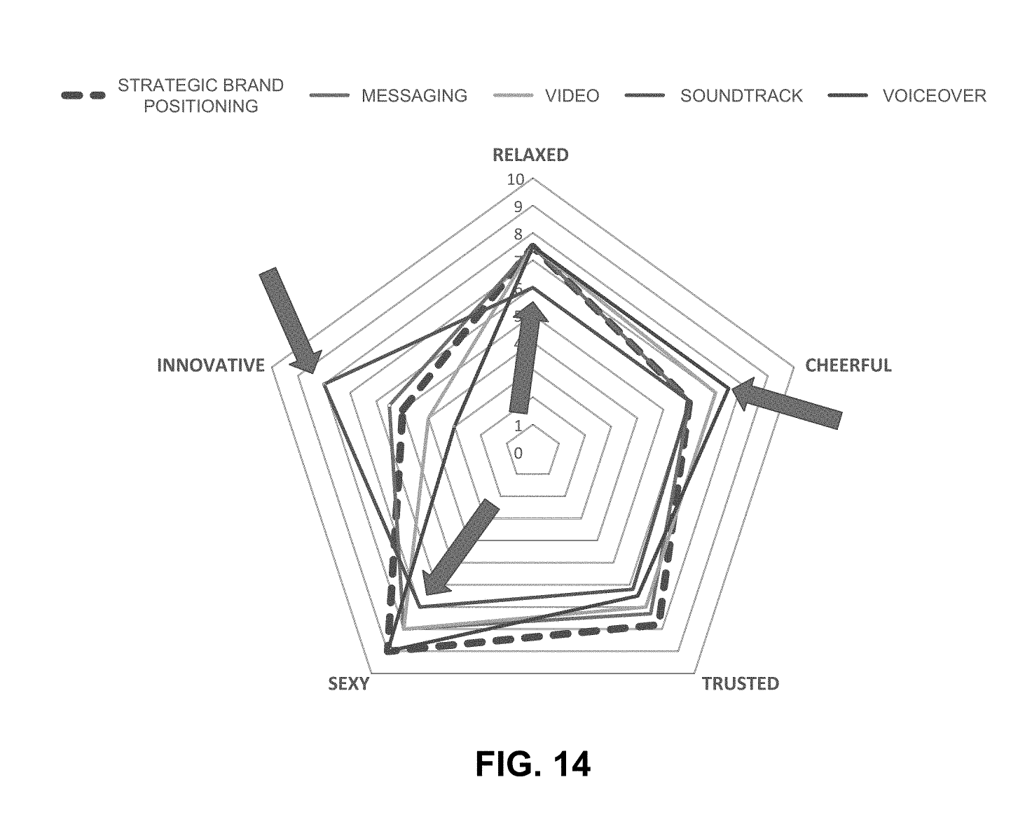

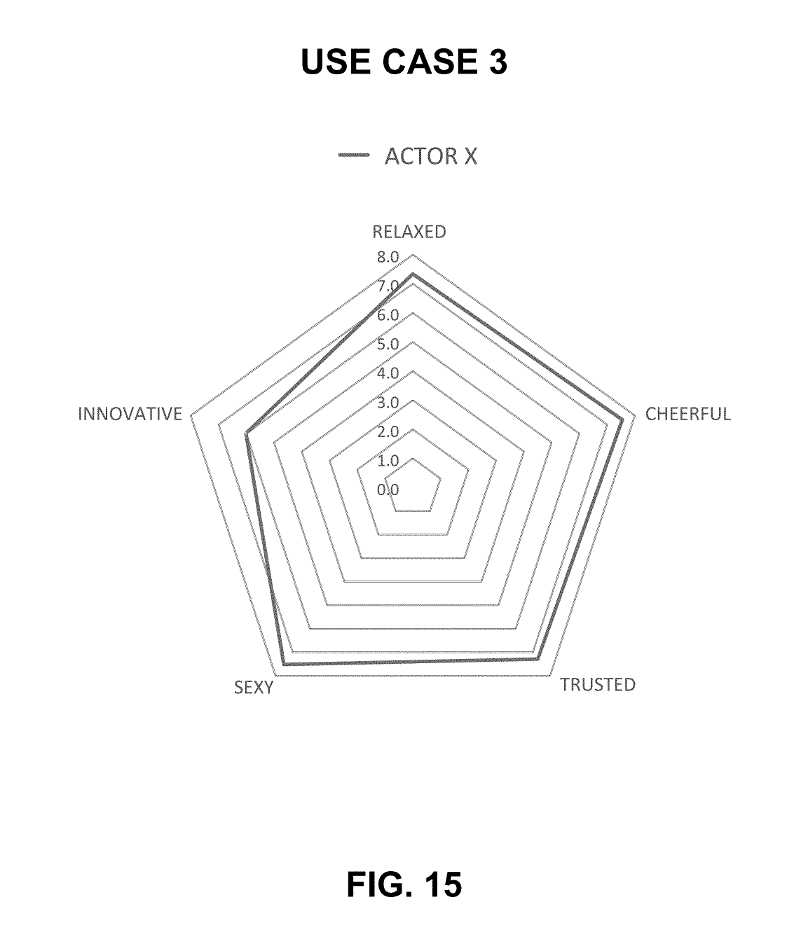

FIGS. 11, 12A, 12B, 13-15, 16A, 16B, 17A, and 17B are schematic diagrams depicting portions of example embodiments of reports. In particular, FIGS. 11-12B are associated with the generation of one report associated with Use Case 1, and FIGS. 13 and 14 are associated with the generation of a report associated with Use Case 2, and FIGS. 15-17B are associated with the generation of a report associated with Use Case 3.

As shown in FIG. 11, an embodiment of a system uses a radar graph to present an aspirational perspective or “personality” that a brand owner desires to be associated with a brand (i.e., Brand X). Using the radar graph, the aspirational brand personality as measured by brand experts is displayed based on an example 0-10 scale, such as described before. In FIG. 12A, the data sets provided by the brand experts (brand strategy) is readily comparable to the brand personality as defined by relevant consumers (brand actual) as the plots for each of brand strategy and actual are presented in an overlying relationship on the radar graph. In FIG. 12B, measured differences between the actual and the perceived brand personality are presented for the components.

In FIG. 13, an embodiment of a system may be used for comparing various constituent components (media points) to a brand strategy. By way of example, representative media points may include messaging, video, soundtrack, and voiceover. By compiling the data sets, such as depicted in FIG. 14, points at which the media items tend not to match the strategic brand positioning may be identified. Examples of such points are indicated by the arrows.

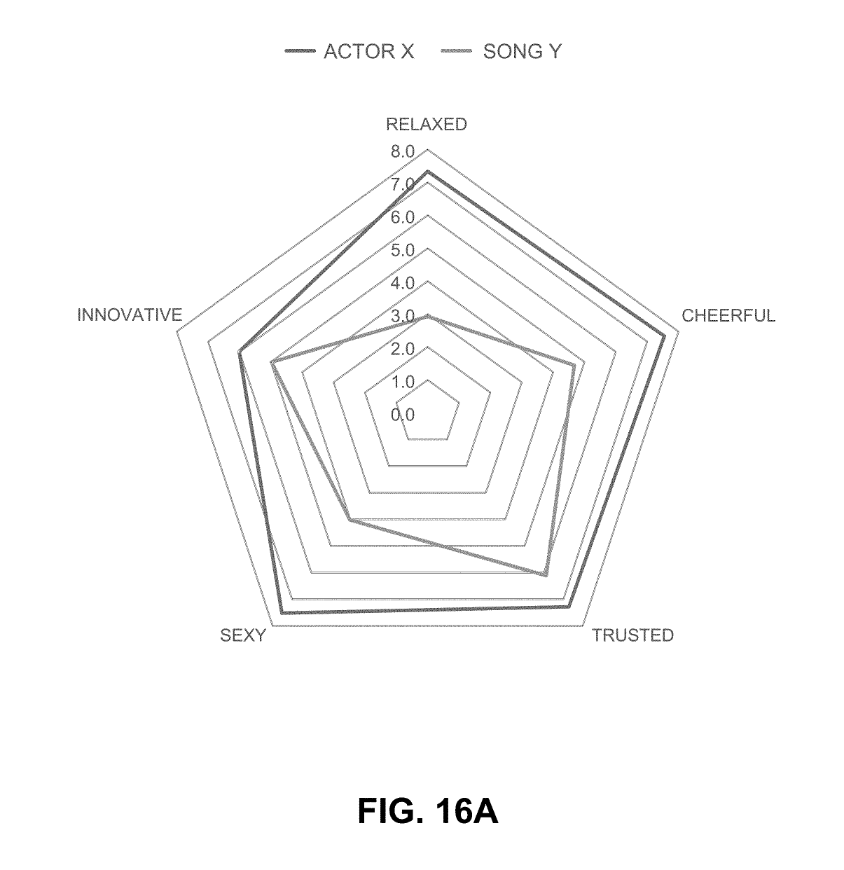

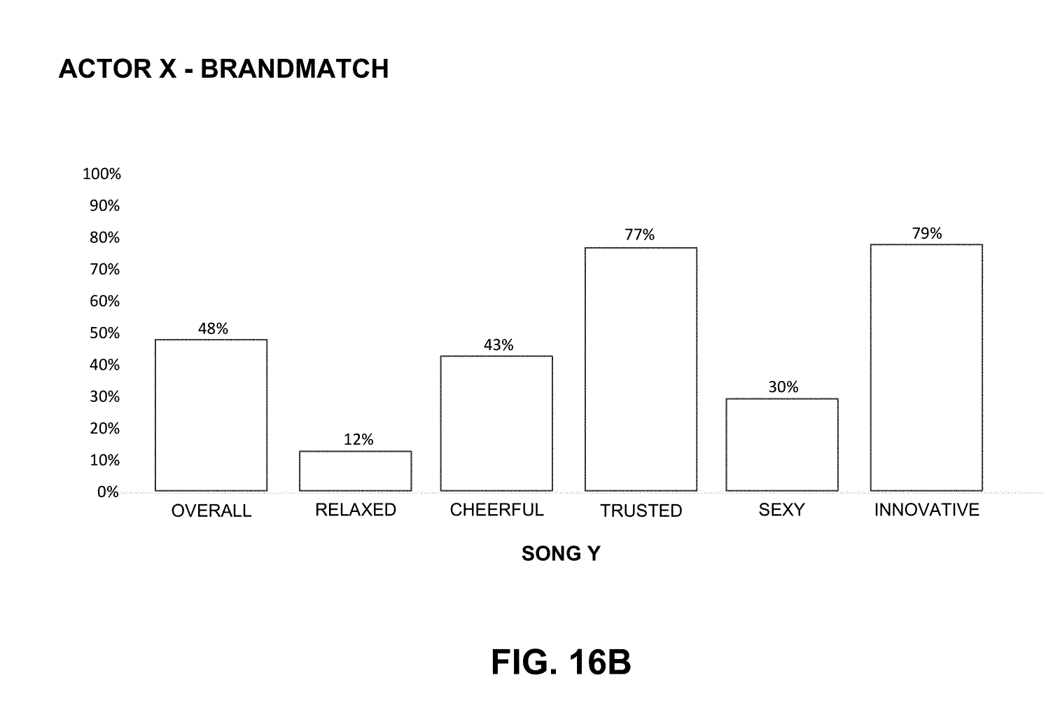

As shown in FIG. 15, an embodiment of a system may be used for the overall component scores of an actor (i.e., Actor X). In FIG. 16A, the component scores of Actor X are compared to component scores of a song (i.e., Song Y) in order to determine whether Song Y is an appropriate song for associating with Actor X. In FIG. 16B, the measured distances between the actor and the song across the measured components, as well as overall, are depicted. As shown, several points at which the song does not match well with the actor may be identified.

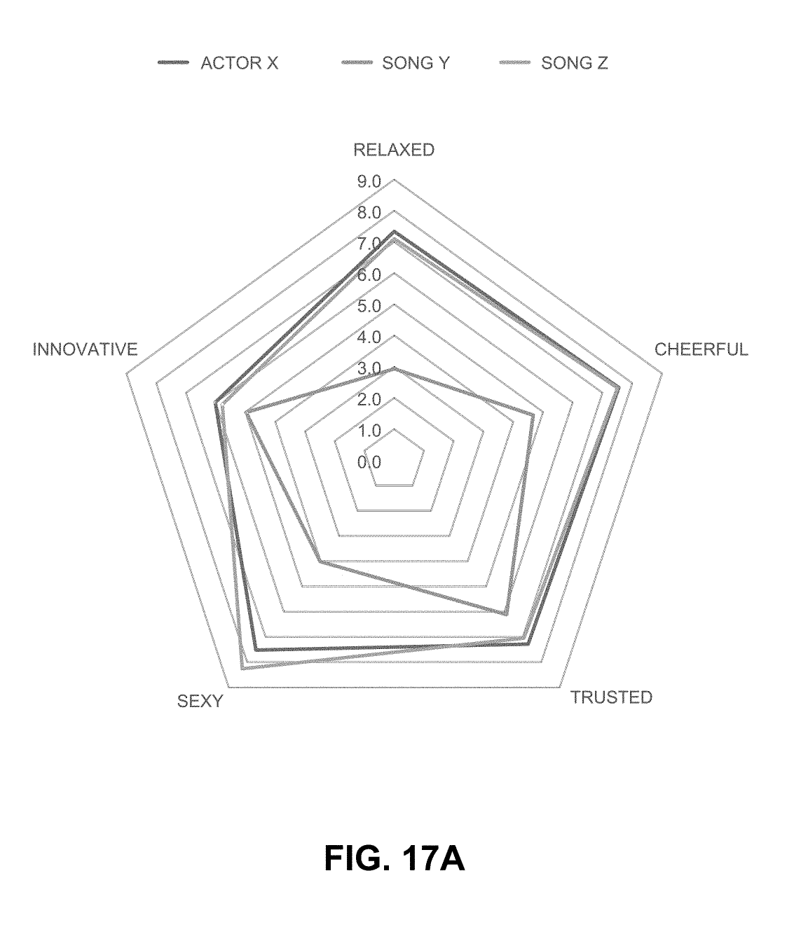

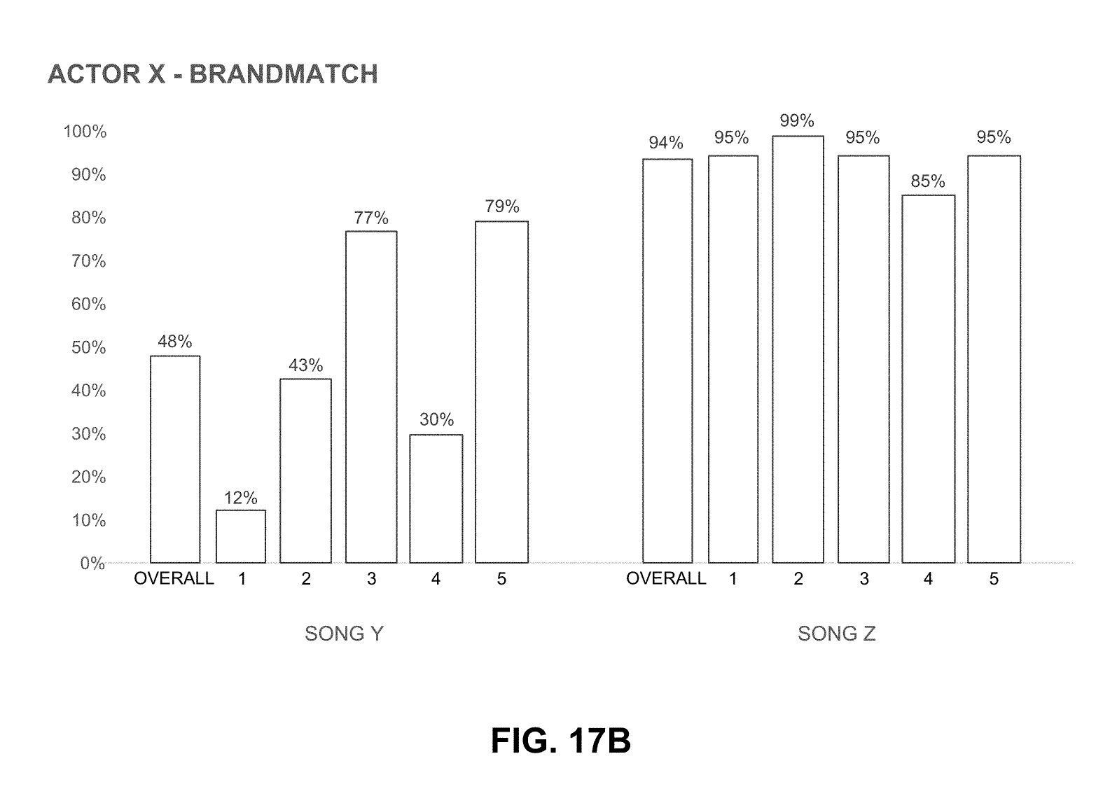

In FIG. 17A, the component scores of Actor X are compared to component scores of two songs (i.e., Song Y and Song Z). As shown in both FIGS. 17A and 17B, Song Z appears to be a better match for Actor X than does Song Y. This output may then be used for informed decision-making when selecting between Actor X associating with various media, such as when making a choice between multiple songs, for example.

Various functions, functional components and/or blocks have been described herein. It should be noted that the functionality described above may be implemented in hardware, software and/or combinations thereof. As will be appreciated by persons skilled in the art, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

In some embodiments, a system configured to perform at least some of the functionality described above may include one or more of a processing device (processor), input/output interfaces, a display, a network/connectivity interface, a memory, an operating system, and a mass storage, with each communicating across a local data bus.

The processing device may include any custom made or commercially available processor, a central processing unit (CPU) or an auxiliary processor among several processors associated with the device, a semiconductor based microprocessor (in the form of a microchip), one or more application specific integrated circuits (ASICs), a plurality of suitably configured digital logic gates, and other electrical configurations comprising discrete elements both individually and in various combinations to coordinate the overall operation of the system.

The memory may include any one of a combination of volatile memory elements (e.g., random-access memory (RAM, such as DRAM, and SRAM, etc.)) and nonvolatile memory elements. The memory typically comprises native operating system, one or more native applications, emulation systems, or emulated applications for any of a variety of operating systems and/or emulated hardware platforms, emulated operating systems, etc. For example, the applications may include application specific software which may comprise some or all the components of the device. In accordance with such embodiments, the components are stored in memory and executed by the processing device.

One of ordinary skill in the art will appreciate that the memory may, and typically will, comprise other components which have been omitted for purposes of brevity. Note that in the context of this disclosure, a non-transitory computer-readable medium stores one or more programs for use by or in connection with an instruction execution system, apparatus, or device.

Network/connectivity interface device comprises various components used to transmit and/or receive data over a networked environment. When such components are embodied as an application, the one or more components may be stored on a non-transitory computer-readable medium and executed by the processing device.

If embodied in software, it should be noted that each described function may represent a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system. The machine code may be converted from the source code, etc. If embodied in hardware, each function may represent a circuit or a number of interconnected circuits to implement the specified logical function(s).

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1. A method for comparing media comprising:
providing a user interface configured to provide media to a reviewer and receive a reviewer input associated with the media, the reviewer input corresponding to a set of attributes exhibited by the media; and
providing a processor, having processor circuitry, configured to:
receive information corresponding to a desired set of attributes;
receive information corresponding to the reviewer input;
automatically compare the information received from the reviewer to the desired set of attributes; and
automatically generate a report based, at least in part, on the information received from the reviewer and the desired set of attributes.

2. The method of claim 1, wherein the desired set of attributes corresponds to current owner perceptions of the media.

3. The method of claim 1, wherein the desired set of attributes corresponds to desired future consumer perceptions of the media.

4. The method of claim 1, wherein in automatically generating the report, the processor is further configured to:
automatically search a database of reviewed media; and
select one of the reviewed media exhibiting at least one attribute identified as lacking between the information received from the reviewer and the desired set of attributes.

5. A system for comparing media comprising:
a user interface configured to provide media to a reviewer and receive a reviewer input associated with the media, the reviewer input corresponding to a set of attributes exhibited by the media; and
a processor, having processor circuitry, configured to:
receive information corresponding to a desired set of media attributes;
receive information corresponding to the reviewer input;
automatically compare the information received from the reviewer to the desired set of attributes; and
automatically generate a report based, at least in part, on the information received from the reviewer and the desired set of attributes.

6. The system of claim 5, wherein the desired set of attributes corresponds to current owner perceptions of the media.

7. The system of claim 5, wherein the desired set of attributes corresponds to desired future consumer perceptions of the media.

8. The system of claim 5, wherein in automatically generating the report, the processor is further configured to:
automatically search a database of reviewed media; and
select one of the reviewed media exhibiting at least one attribute identified as lacking between the information received from the reviewer and the desired set of attributes.

9. A non-transitory computer-readable medium having stored thereon computer-executable instructions for comparing media, the computer-executable instructions being configured to:
provide media to a reviewer;
receive a reviewer input associated with the media, the reviewer input corresponding to a set of attributes exhibited by the media;
receive information corresponding to a desired set of attributes;
receive information corresponding to the reviewer input;
automatically compare the information received from the reviewer to the desired set of attributes; and
automatically generate a report based, at least in part, on the information received from the reviewer and the desired set of attributes.

10. The non-transitory computer-readable medium of claim 9, wherein the desired set of attributes corresponds to current owner perceptions of the media.

11. The non-transitory computer-readable medium of claim 9, wherein the desired set of attributes corresponds to desired future consumer perceptions of the media.

12. The non-transitory computer-readable medium of claim 9, wherein in automatically generating the report, the computer-executable instructions are further configured to:
automatically search a database of reviewed media; and
select one of the reviewed media exhibiting at least one attribute identified as lacking between the information received from the reviewer and the desired set of attributes.
